(19) United States
(12) Patent Application Publication
(10) Pub. No.: US 2011/0080960 A1
(43) Pub. Date: Apr. 7, 2011

(54) METHOD AND SYSTEM FOR EFFICIENT TRANSMISSION OF ANTI-CAMCORDER VIDEO

(76) Inventor: Donald Henry Willis, Indianapolis, IN (US)

(21) Appl. No.: 12/737,111

(22) PCT Filed: Jun. 27, 2008
(86) PCT No.: PCT/US2008/008079

§ 371 Date: Dec. 8, 2010

(51) Int. Cl. H04N 7/24

(52) U.S. Cl. 375/240.26; 375/E07.003

(57) ABSTRACT

In embodiments of the present principles, the transmission bit rate of a video stream including anti-camcorder measures can be reduced while maintaining anti-camcorder effects and video quality. In one embodiment, a segmentor is included to segment a portion of a frame, such as a pixel, into most significant bits and least significant bits. A representative LSB can be generated and employed for concatenation with each MSB value of a sample set of portions of frames. Use of the representative LSB values in lieu of LSB values of the sample set enables an efficient transmission bit rate, as the representative LSB value can have less bits than the LSB of an original portion and can be reused with a plurality of MSB values of a sample set of portions.

### TECHNICAL FIELD

The present invention generally relates to bit-rate efficiency, and more particularly to methods, apparatuses and systems for reducing the transmission bit rate of a video stream subjected to anti-camcorder modulation.

### BACKGROUND

Unauthorized copying and distribution of films in recent years has resulted in a significant loss of revenue for film producers. Pirated copies of newly produced films are often obtained by recording presentations of films in theaters using camcorders. To curb pirate copying, anti-camcorder measures incorporating high frame-display rates were developed. However, the high frame-display rates have resulted in high transmission bit rates between various components in a video presentation system.

For example, in a high quality digital display system, a display resolution is commonly two million pixels or more with a display bit depth that is typically twelve bits per Red-Green-Blue component. Oftentimes, anti-camcorder schemes incorporate display rates of 120 Hz or higher. As a result, the transmission bit rate could be as high as eight or nine gigabytes per second or more. Thus, there exists a need to reduce the transmission bit rate while retaining the quality and security of a video incorporating anti-camcorder measures.

### SUMMARY

A method, system and apparatus in accordance with various embodiments of the present invention addresses the deficiencies of the prior art by providing efficient transmission of videos including anti-camcorder measures while maintaining quality and security.

In one embodiment of the present invention, a method for reducing the transmission bit rate of a video stream subjected to anti-camcorder modulation includes modulating a portion of an original frame such that the presentation of a display set of frame portions includes effects that are perceptible within a copy of the presentation recorded with a recording device but are imperceptible in the presentation; segmenting the portion of an original frame into most significant bits (MSB) and least significant bits (LSB); generating a representative LSB value; and transmitting the representative LSB value and MSB of a plurality of modulated portions for their concatenation with the representative LSB value to form the display set and for presentation of the display set.

In an alternate embodiment of the present invention, a system for reducing the transmission bit rate of a video stream subjected to anti-camcorder modulation includes a coder, configured to transmit a representative LSB value and MSB of a plurality of modulated portions, including: a modulator configured to modulate a portion of an original frame such that the presentation of a display set of frame portions includes effects that are perceptible within a copy of the presentation recorded with a recording device but are imperceptible in the presentation, a segmentor configured to segment the portion of an original frame into MSB and LSB, a generator module configured to generate a representative LSB value; and a decoder including a concatenator configured to concatenate, for the MSB of each of the plurality of modulated portions, the MSB of a modulated portion with the representative LSB value to generate the display set.

In an alternate embodiment of the present invention, an apparatus for reducing the transmission bit rate of a video stream subjected to anti-camcorder modulation includes a modulator configured to modulate a portion of an original frame such that the presentation of a display set of frame portions includes effects that are perceptible within a copy of the presentation recorded with a recording device but are imperceptible in the presentation; a processor configured to segment the portion of an original frame into MSB and LSB, generate a representative LSB value, and drive the transmission of the representative LSB value and MSB of a plurality of modulated portions for their concatenation with the representative LSB value to form the display set and for presentation of the display set; and a memory (522-1) configured to store MSB and LSB of portions.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for generating, transmitting and presenting a video stream including anti-camcorder effects with an efficient transmission bit rate.

FIG. 2 depicts a high level block diagram of a coder suitable for use in the system of FIG. 1 in accordance with an embodiment of the present invention;

FIG. 3 depicts a high level block diagram of a decoder suitable for use in the system of FIG. 1 in accordance with an embodiment of the present invention;

FIG. 4 depicts a representation of a pixel in a video stream including anti-camcorder effects that is output subsequent to efficient bit-rate transmission;

FIG. 5 depicts a high level block diagram of a coder apparatus suitable for use in the system of FIG. 1 in accordance with an embodiment of the present invention;

FIG. 6 depicts a high level flow diagram of a method for reducing the transmission bit rate of a video stream subjected to anti-camcorder modulation in accordance with an embodiment of the present invention;

FIG. 7 depicts a high level flow diagram of a method for decoding an efficient bit-rate transmission stream incorporating anti-camcorder modulation in accordance with an embodiment of the present invention;

FIG. 8 depicts a high level block diagram of a modulator suitable for use with system 200 or apparatus 500 in accordance with an embodiment of the present invention; and

FIG. 9 depicts a high level flow diagram of a method for modulating a portion of a frame to incorporate anti-camcorder effects in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF PREFERRED EMBODIMENTS

The present invention advantageously provides a method, apparatus and system for providing bit-rate efficient transmission of video streams incorporating anti-camcorder measures. Although the present invention will be described primarily within the context of a coder/decoder system and a coding device used for the transmission of anti-camcorder video streams, the specific embodiments of the present invention should not be treated as limiting the scope of the invention. It will be appreciated by those skilled in the art and informed by the teachings of the present invention that the concepts of the present invention can be advantageously applied in the transmission of other types of data. For example, the concepts of the present invention can be implemented in data files transmitted between devices in a local area network, a wide area network and the like.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

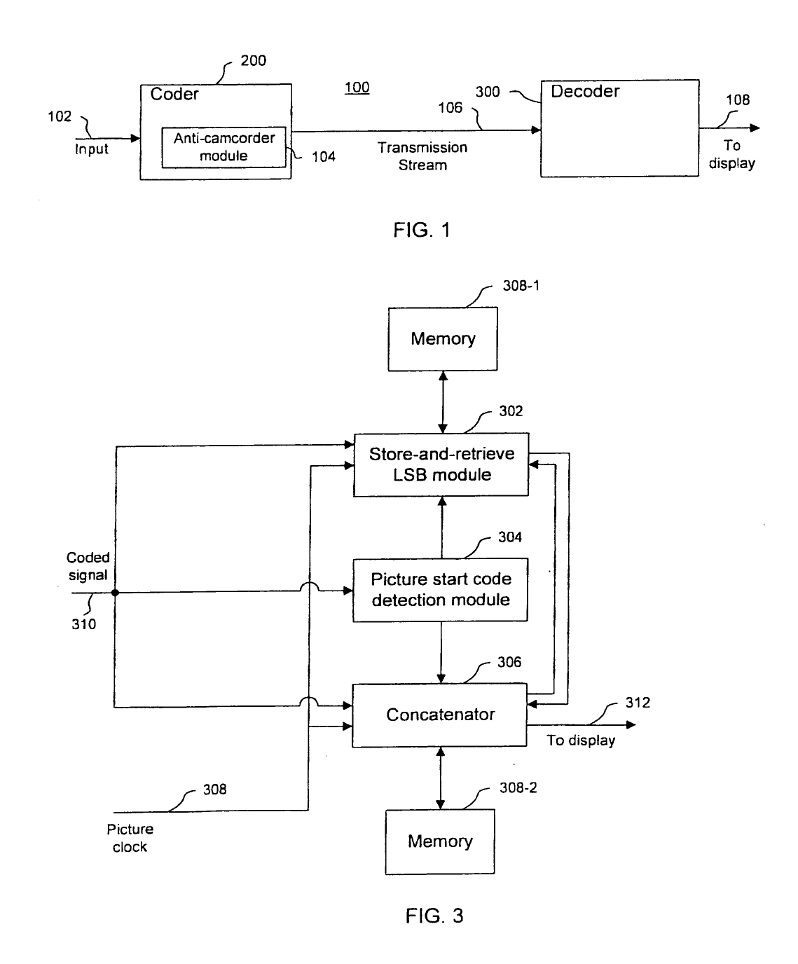

Referring now in specific detail to the drawings in which like reference numerals identify similar or identical elements throughout the several views, and initially to FIG. 1, an exemplary system for presenting a digital video stream with anti-camcorder features in a cinema theater in accordance with embodiments of the present invention is depicted. The system of FIG. 1 illustratively includes a coder 200, an anti-camcorder module 104 and a decoder 300. In accordance with one exemplary embodiment, an original video stream with a 24 Hz frame display rate, for example, can be input to the coder 200 through line 102. The anti-camcorder module 104 can modify the original video stream to include anti-camcorder effects so that pirate copying of the video is discouraged. Thereafter, the modified video stream is transmitted through line 106 in a transmission stream to decoder 300 and through line 108 for display in a cinema theater.

Anti-camcorder effects operate on the principle that camcorders record video based on temporal sampling. For example, a camcorder device operates at a fixed frequency, such as 60 Hz for National Television System Committee (NTSC) signals and 50 Hz for Phase Alternating Line (PAL) signals. Other camcorders can operate at a capture rate of 24 Hz and thereby coincide with the frame rate of an original video stream. Due to the fact that the human eye does not perform temporal sampling to process views, aliasing effects can be incorporated into a video stream that are perceptible in a camcorder recording of the video presentation but are imperceptible when the video stream is viewed directly by the human eye.

Anti-camcorder effects can be incorporated into a video stream by, for example, modifying an original video stream to have a high display rate and modulating the video stream at a frequency that is imperceptible by the human eye. For example, the display rate can be 120 Hz and the modulation frequency can be approximately 55 Hz, as people typically cannot perceive an effect displayed at 55 Hz. In contrast, a camcorder recording would display the anti-camcorder effects, which can, for example, manifest as an irritating flicker. However, it should be understood that the display rate and modulation frequency can be varied to provide an effective anti-camcorder scheme. One suitable modification can be configuring the display rate to be between 110 Hz and 125 Hz, for example.

Direct transmission of the modulated video stream can result in a high transmission bit rate due to its high frame display rate. In accordance with one or more embodiments of the present invention, the transmission bit rate can be reduced by segmenting portions of a frame, such as segmenting pixels, for example, into most significant bits (MSB) and least significant bits (LSB). The portion segmented can be the portion of an original video frame or can be a portion within a sample set of portions created from the original portion to increase the display rate and/or to create a modulated video stream. A representative LSB value can be generated from the original frame portion or from the portions in the sample set. The representative LSB value and the MSB of a sample set can be transmitted to the decoder for concatenation of the representative LSB value with each MSB of the sample set to form a display set of portions of frames. Advantageously, in accordance with an embodiment of the present principles, the transmission bit rate can be reduced, as the representative LSB value can have less total bits than the LSB of portions in a sample set transmitted to a decoder. Further, the representative LSB value can be transmitted once and can be incorporated in multiple frames, as opposed to transmitting the LSB of each individual sample in a sample set. Moreover, the transmission bit rate can be reduced while maintaining modulation information and a high display frame rate, as the modulation information can be preserved within the MSB portions of the display set, as discussed more fully below.

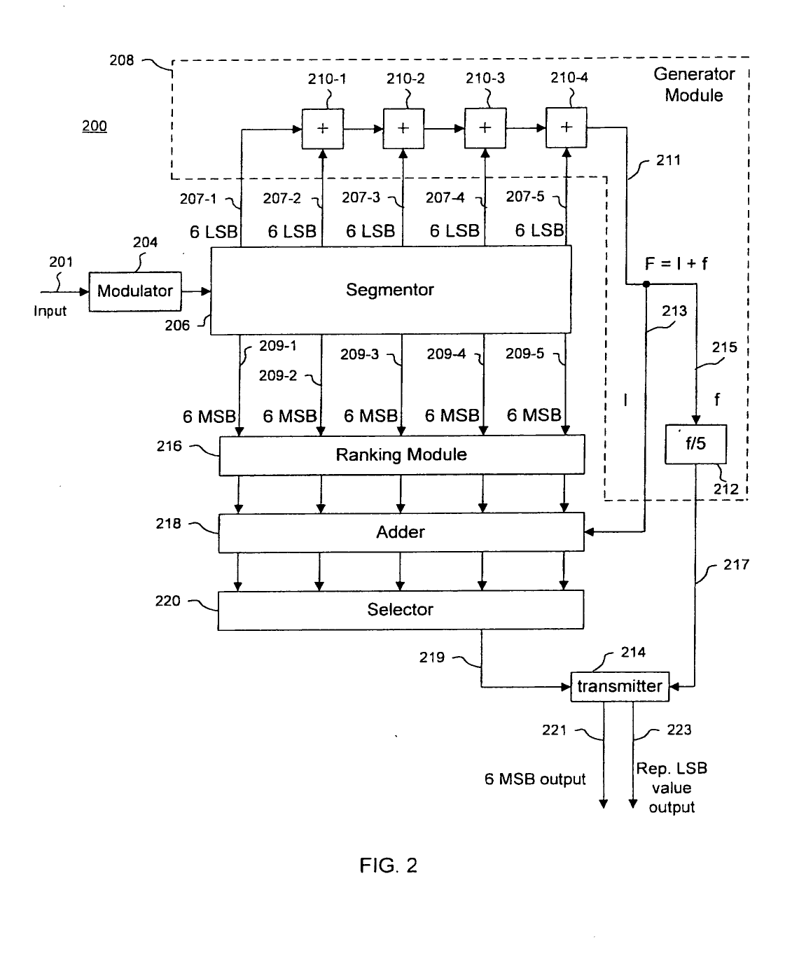

Referring now to FIG. 2, an embodiment of a coder 200 for modulating a video bit stream and for transmitting the video stream at an efficient bit rate in accordance with an embodiment of the present invention is illustrated. The coder 200 illustratively includes one or more modulators 204, a segmentor 206, a generator module 208, including adders 210 and a dividing module 212, a transmitter 214, a ranking module 216, an adder 218, and a selector 220.

In the embodiment of FIG. 2, the modulator 204, can, for example, compose the anti-camcorder module 104 described above. In accordance with one embodiment of the present invention, the coder 200 receives an input corresponding to a portion of a frame, such as a 12-bit pixel, for example, through line 201. The pixel information can be repeated and multiplied by the modulator 204 to form a modulated sample set of pixels that correspond to the same frame location as the original pixel. The sample set can be formed to increase the display rate of the video stream. For example, the sample set can include five samples, however, it should be understood that the number of samples can be varied and need not be constant throughout the process. For example, one sample set can include three samples for one frame and another sample set can include six samples for another frame. Further, each sample in the set can correspond to the same pixel location as the pixel in the original frame that was multiplied.

The sample set can be modulated by the modulator 204 at a frequency of 55 Hz, for example, as discussed above. The modulation is configured such that the presentation of a display set of frame portions includes effects that are perceptible within a copy of the presentation recorded with a recording device but are imperceptible in the presentation by human eyes. The display set is the set of samples that are displayed subsequent to processing by the coder and decoder in system 100, for example, and is discussed in more detail below. The modulation performed by the modulator 204 can, for example, be configured so that the average brightness of the samples in the display set is the brightness of the original pixel. In this way, the human eye would perceive the original pixel brightness despite the modulation.

It should also be noted that a pixel is only one example of a portion of a frame. Although the present principles are described with respect to pixels, embodiments of the present invention can be applied to other portion sizes as well. Furthermore, a “12-bit pixel,” as referred to herein, can correspond to one of a Red, Green, or Blue signal, for example.

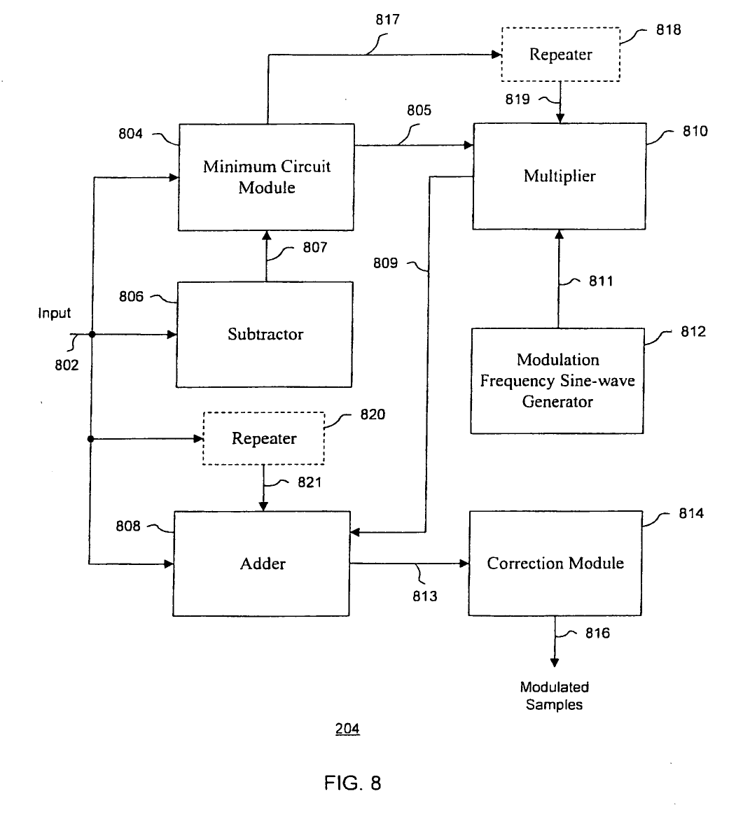

Referring now to FIG. 8, a block diagram illustrating a more detailed description of an embodiment of a modulator 204 in accordance with the present invention is illustrated. The modulator 204 of FIG. 8 includes a minimum circuit module 804, a subtractor 806, an adder 808, optional repeaters 818 and 820, a multiplier 810, a Modulation Frequency Sine-wave Generator 812 and a correction module 814. The minimum circuit module 804 can be configured to select the minimum bit value of two inputs, 802 and 807. Input 802 can comprise a pixel of an original video frame and input 807 can be received from subtractor 806. As stated above, the input 802 can comprise, for example, a 12-bit pixel video with a frame rate of 24 Hz. The subtractor 806 can be adapted to subtract input 802 from the maximum value at the input 802. For example, for a 12-bit pixel input, the maximum value at input 802 can be 4095. The multiplier 810 can be configured to generate a sample set of pixel values by multiplying the output 805 of the minimum circuit module 804 by samples of a modulation frequency sine-wave received from the generator 812 along line 811. The sample set is then transmitted to an adder 808.

Alternatively, the sample set can be generated by an optional repeater 818. The optional repeater 818 can be configured to repeat input pixel information received from the minimum circuit module along line 817 to form a sample set of values. Each sample in the sample set can be multiplied by samples of a modulation frequency sine-wave received from the generator 812 along line 811. The sample set can be transmitted to the multiplier 810 along line 819, which can correspond to a 120 Hz display rate if there are five samples in the sample set, for example. The sample set is then transmitted to an adder 808.

The sample set can be transmitted along line 809 to the adder 808, which adds the original input pixel value 802 to the sample set values received along line 802. The frame display rate along line 809, in one embodiment, can be 120 Hz if there are five samples in the sample set, for example. The original input pixel value 802 can be provided to the adder by an optional repeater 820. Similar to repeater 818, the repeater 820 can be configured to repeat input pixel information. The repeated information can be transmitted along line 821, which can also correspond to a 120 Hz frame display rate if there are five samples in the sample set, for example.

The output of adder 808 along line 813 can be a raw set of modulated pixels. The raw set of modulated pixels can be corrected by a correction module 814 to ensure that an average bit value of the sample set of modulated pixels corresponding to a display set of pixels is the bit value of the pixel of an original frame, such as input 802. The corrected modulated samples of a sample set can be output along line 816.

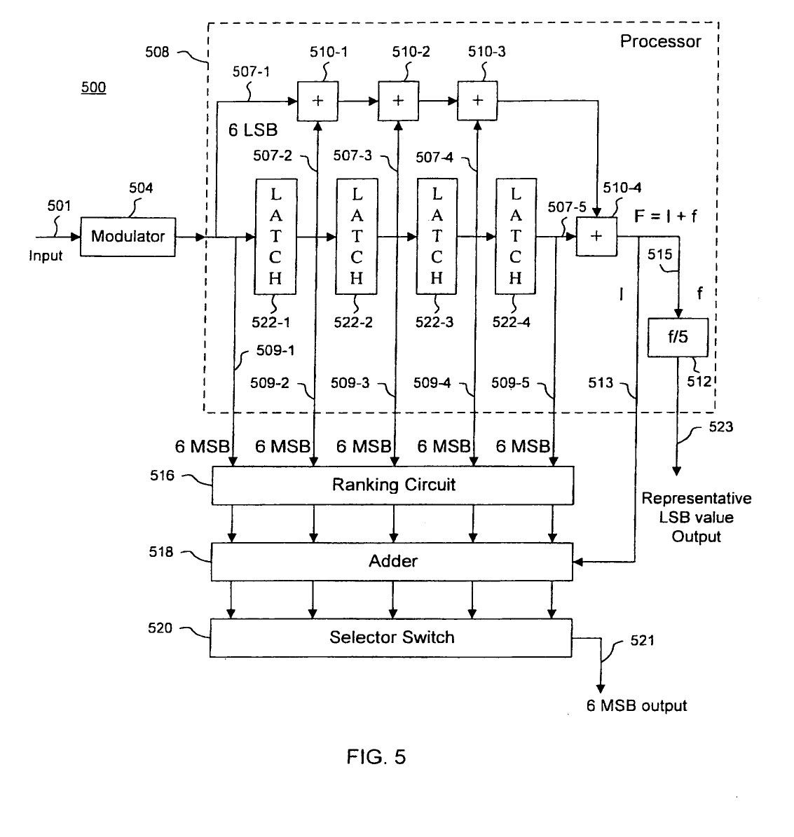

Returning to FIG. 2 and referring to FIG. 5, subsequent to the generation of modulated samples in a sample set, the sample set can be stored within a segmentor 206. With reference to FIG. 5, the sample set can be stored in a series of latches 502, for example. The segmentor 206 segments each 12-bit sample in the sample set into 6 MSB and 6 LSB as shown in FIG. 2. For example, the 6 LSB of each sample in the sample set can be transmitted through lines 207-1 to 207-5, respectively, and the 6 MSB of each sample in the sample set can be transmitted through lines 209-1 to 209-5, respectively. As discussed above, in this particular example, the sample set consists of five samples for the pixel processed. Additionally, in this particular example, the 6 MSB and 6 LSB respectively correspond to the integer and the fraction of the sample's bit value. The segmentor 206 transmits the LSB of each sample to a generator module 208 and transmits the MSB of each sample to a ranking module 216. However, it should be understood that the partition of the pixel need not be done to form parts having the same number of bits. For example, the segmentor 206 can segment the samples in 3 MSB and 9 LSB if the modulation is adequately implemented within the 3 MSB of the samples. Further, it should also be understood that the ranking module 216, discussed below, can be an optional element.

After receiving the LSB of the samples in the sample set, the generator module 208 can add the LSB of the samples using adders 210-1 to 210-4 to calculate their sum, F, comprising an integer, I, and a fraction, f, which is transmitted in line 211. F can be split into I and f and transmitted along lines 213 and 215, respectively. For exemplary purposes, I can be the MSB and f can be the LSB. Further, I can correspond to three bits and f can correspond to six bits. Thereafter, a dividing module 212 can divide f by the number of samples in the sample set, which in this case is five, to generate the Representative LSB value, mentioned above. However, it should be understood that the Representative LSB value can be generated from the original pixel value, as discussed more fully below with respect to a numerical example, by generator module 208. In this example, because of a division by five, the number of bits can be reduced. As such, the representative LSB value can comprise four bits, which can be transmitted on line 217. The Representative LSB value can be transmitted via transmitter 214 along line 223 to a decoder while the I can be sent to the adder 218 along line 213.

Returning to the ranking module 216, the MSB of the samples can be transmitted to the ranking module 216, as mentioned above, to rank the MSB of the samples. In this exemplary embodiment, the ranking module 216 can determine the rank of the MSB in magnitude order, where the largest sample is rank one and the smallest sample is rank five. The ranking can be appended to the six-bit samples to form nine-bit values. The ranked MSB of the samples are sent to the adder 218.

As mentioned above, the adder 218 receives I, the integer of the sum F of the LSB of the samples, and can increment the MSB values to distribute the value of I. For example, the adder can increase by one each MSB value that meets the following conditions: the MSB value is not all ones and the MSB value has a ranking that is equal to or less than I, which in this case is the integer of the sum of the LSB of the portions in the sample set. The incrementing is performed to incorporate information included in I within the MSB values so that it is not lost and so that the quality of the video is maintained. Although incrementing by one is described, the present invention is not limited to such an incrementing and I can be preserved within one or more MSB values in different ways. For example, as discussed more fully below with respect to a numerical example, a multiple of a minimum value of a least significant bit of a MSB of a modulated pixel can be added to the MSB of a modulated pixel as long as the incremented MSB result is not larger than an MSB of all ones.

However, it can be desirable to increment the largest MSB values first so as to minimally affect the modulation information included in the MSB values. It should be understood that the incrementing need not be limited to the largest MSB values if anti-camcorder effects are sufficiently present in the display of the modified video stream. Furthermore, it should also be understood that other embodiments of the present invention can include a coder that does not utilize a ranking module. For example, any MSB values in the set can be incremented to incorporate I. While, in the example provided in FIG. 2, the MSB values with the greatest magnitude are incremented first to minimally affect modulation, MSB values in the set can be incremented in any order.

Subsequent to the incrementing, the MSB values of the samples can be transmitted to a selector 220. The process can be repeated for each pixel or portion in a frame to generate corresponding MSB and representative LSB values. Further, it should be understood that coder timing can be implemented in a variety of ways. For example, the coder can be configured with enough memory so that the above calculations need to be performed only once per sample set and stored. However, with a low-memory coder, the calculations can be repeated for each output picture.

Returning to selection of the MSB values, the selector 220 can be configured to output the proper MSB sample at the proper time. For example, the selector 220 can be a multiplexer and can transmit MSB values to transmitter 214 via line 219, which can then transmit the values via line 221 in a transmission stream. In this specific example, the MSB value is six bits. After selection, the MSB of the samples are transmitted in a transmission stream to a decoder for concatenation and presentation of a display set.

The transmission stream can be configured to include a portion reserved for an incoming picture clock to indicate the start of a new picture. One byte following the picture clock can be an indicator of the number of output pictures generated from one input picture. Following a valid picture clock code, the incoming bit stream can carry the representative LSB values of all or some pixels of the incoming picture. In addition, the bit stream can carry the MSB values of samples in some or all sample sets corresponding to the pixels of the representative LSB values transmitted. The decoder receiving the transmission stream can compile the pixel information to generate a set of frames for display.

FIG. 3 depicts a high level block diagram of a decoder suitable for use in the system of FIG. 1 in accordance with an embodiment of the present invention. For example, the decoder 300 of FIG. 3 can receive the representative LSB value and the MSB of the samples in the sample set in line 310 from coder 200, for example. The picture clock is transmitted in FIG. 3 in line 308. The decoder 300 can include a store-and-retrieve LSB module 302, memories 308-1 and 308-2, a picture start code detection module 304, and a concatenator 306. In one embodiment, modules 302-306 can be implemented as one or more processors running software. Additionally, modules 302-306 can be implemented as individual, corresponding circuits. As described above, the transmission stream can include a portion reserved for an incoming picture clock. The picture start code detection module 304 is configured to detect a valid picture clock code. As the representative LSB values are received, the store-and-retrieve LSB module 302 can store the representative LSB values to memory 308-1. After the representative LSB values of some or all pixels of one or more frames are stored, the following transmitted bits can carry the MSB values of samples in some or all sample sets of one or more frames, as described above. The concatentor 306 can be configured to store the incoming MSB values. Although the representative LSB values are described as being transmitted before the MSB values of samples, in alternate embodiments of the present invention, they can be transmitted after and/or with MSB values of samples.

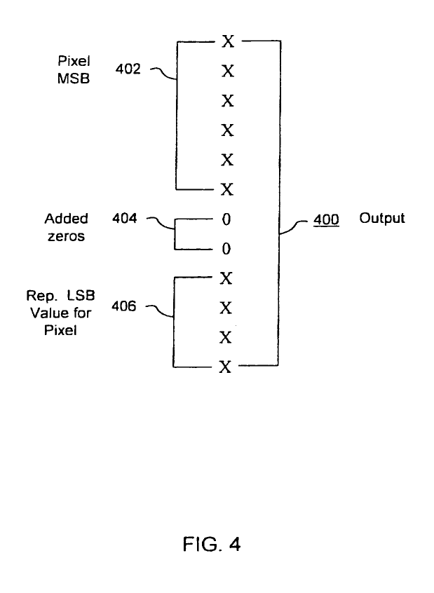

In the exemplary embodiment described above, the six-bit MSB values can arrive faster than they can be outputted. The concatentor 306 can direct the excess MSB to be stored in memory 308-2, for example. When the first MSB value is available, the concatenator 306 can request the representative LSB value for the MSB value's corresponding pixel. The concatenator then concatenates the bits to form a displayable pixel. One example of the concatenation is provided in FIG. 4, corresponding to the example described with respect to FIG. 2, in which a four-bit representative LSB value and six-bit MSB values in a sample set are generated. That is, FIG. 4 depicts a representation of a pixel in a video stream including anti-camcorder effects that is output subsequent to efficient bit-rate transmission.

With reference to FIGS. 4 and 8, the six-bit MSB 402 are combined with the four-bit representative LSB value 406 of a pixel with added zeros 406 in between to form a 12-bit output 400. The representative LSB value can be “reused” in the sense that it can be combined with every MSB value in a sample set. As discussed above with respect to FIG. 8, the sample set is generated by repeating, multiplying and/or modulating a particular pixel in an original picture to incorporate anti-camcorder effects. As opposed to transmitting the entire bit-word for each sample in the sample set, the transmission bit rate can be reduced by transmitting a portion of each sample. In this example, only the MSB of each sample is transmitted along with a representative LSB value that can be “reused” for each sample in the set.

Referring to FIG. 4, it should be understood that the displayable pixel is one sample in a display set. A display set is the set of values or displayable pixels obtained from concatenating the MSB of each sample in a sample set with its corresponding representative LSB value. Thus, each sample in the display set can correspond to the same pixel location in different output frames. Likewise, the representative LSB value can be included in a plurality of frames corresponding to the display set.

It should be noted that the samples in the display set are typically not displayed simultaneously, as they are included in different frames. In addition, each frame in a display of the modified video stream can be generated by compiling the concatenated values for each pixel in the output frame. Further, as discussed above, the average brightness of the samples in a display set is the brightness of the original pixel, which has the same corresponding pixel location in the different display frames corresponding to a display set. As discussed above, because the average brightness of the pixels in a display set is the brightness of a pixel in a picture of the original video stream, the human eye will perceive little or no difference between the displayed pixels and the pixels of an original frame. Moreover, as discussed above, presentation of the modulated pixels in the display set includes effects that are perceptible within a copy of the presentation recording with a recording device. Thus, aspects of the present principles enable reduction of a transmission bit rate while maintaining modulation and a high frame display rate.

Referring now to FIG. 5 with continuing reference to FIG. 2, an exemplary apparatus in accordance with one embodiment of the present invention is illustrated. As shown in FIG. 5, a coder is implemented by employing a processor 508 that is configured to run software and perform the functions of the segmentor 206 and the generator module 208, discussed at length above, by employing adders 510, dividing module 512 and storage latches 522. Furthermore, the processor 508 can be configured to drive the transmission of the representative LSB value and MSB of a plurality of modulated pixels for their concatenation with the representative LSB value to form the display set and for presentation of the display set. Similarly, the modulator 504, the ranking circuit 516 and the selector switch 520 can be configured to perform the functions of modulator 204, ranking module 216 and the selector 220, respectively, as discussed above. Likewise, lines 501, 507-1 to 507-5, 509-1 to 509-5, 515, 513, 521 and 523 can carry the same or similar information as lines 201, 207-1 to 207-5, 209-1 to 209-5, 215, 213, 221 and 223, respectively, as discussed above. Moreover, the coder 500 can be implemented with decoder 300, also discussed at length above.

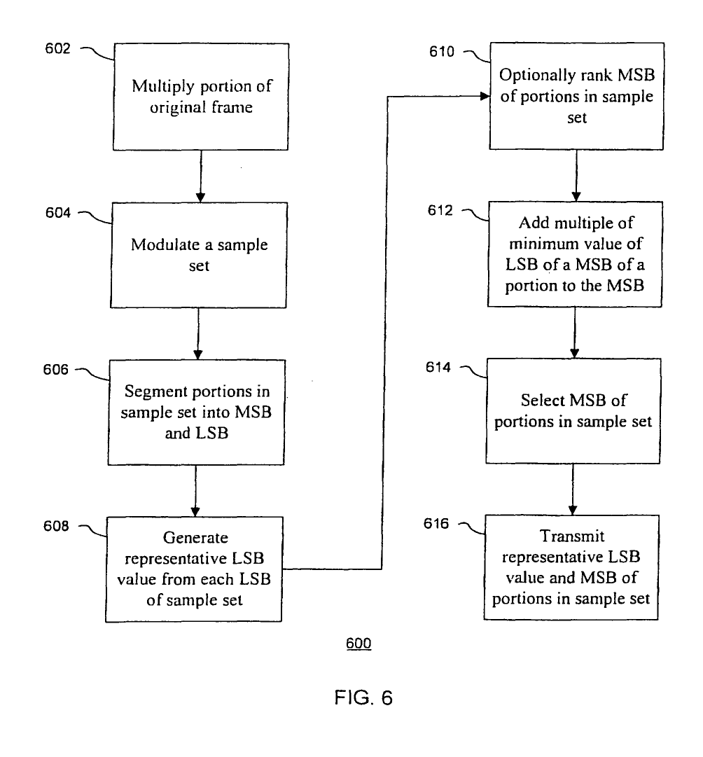

FIG. 6 depicts a high level flow diagram of a method for reducing the transmission bit rate of a video stream subjected to anti-camcorder modulation in accordance with an embodiment of the present invention. With reference to FIG. 6 and continuing reference to FIG. 2, a method 600 for reducing the transmission bit rate of a video stream subjected to anti-camcorder modulation is illustrated. The method 600 can be implemented in coder 200, as described above. Method 600 can begin at step 602 in which a portion of an original frame is multiplied into a sample set of portions, wherein each portion in the sample set corresponds to the same frame location, as described above, for example, with respect to modulator 204. Alternatively, however, as stated above, the sample set can be generated by a repeater. In the alternative implementation, each sample in the sample set can be multiplied in step 602 by a corresponding modulation frequency sample, such as a sine wave sample. The method 600 then proceeds to step 604.

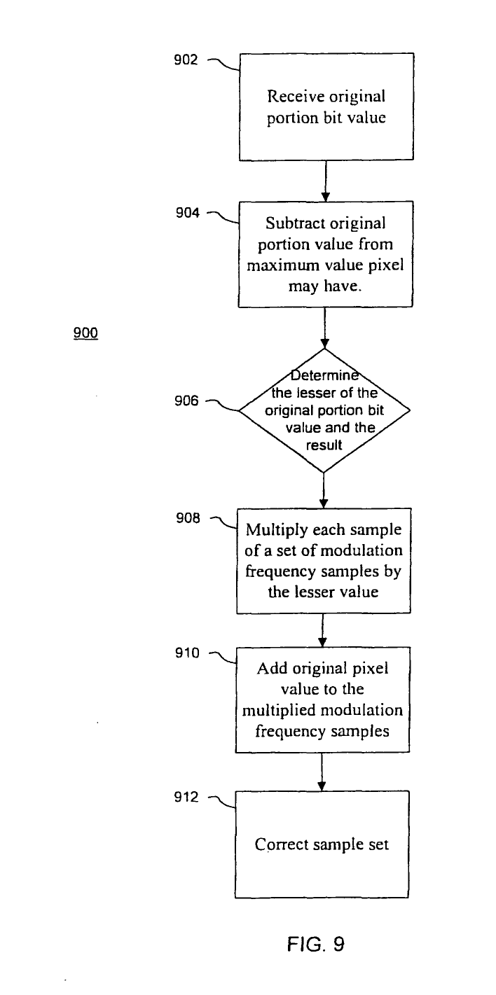

At step 604, the portions in the sample set are modulated such that the presentation of a display set of frame portions includes effects that are perceptible within a copy of the presentation recorded with a recording device but are imperceptible in the presentation, as described above with respect to modulator 204. However, it should be noted that the modulation step can be combined with the multiplication of the original frame portion to form the sample set, as discussed more fully with respect to FIG. 9.

That is, FIG. 9 depicts a high level flow diagram of a method for modulating a portion of a frame to incorporate anti-camcorder effects in accordance with an embodiment of the present invention. With reference to FIG. 9 and FIGS. 6 and 8, an illustrative example of a method implementation 900 for generating a modulated sample set of pixel values is shown. That is, the method 900 can be implemented in step 604 of method 600. The method 900 begins in step 902 in which, a pixel bit value of a frame of an original video stream is received, for example, in input 802. As stated above, for example, the frame rate of the original video stream can be 24 Hz and the frames of video stream 802 can be comprised of 12-bit pixels. The method 900 then proceeds to step 904.

At step 904, an original pixel bit value, which can be received in input 802, is subtracted from the maximum value the pixel can have. For example, as stated above, for a 12-bit pixel, the maximum value of the pixel is 4095. In modulator 204, subtractor 806 can perform step 904 and the result can be transmitted along line 807. The method 900 then proceeds to step 906.

At step 906, the result is compared with the original pixel value to determine the lesser of the two. For example, the minimum circuit module 804 can perform step 906 to obtain the lesser of the original pixel value of input 802 and the output of subtractor 806. The method 900 then proceeds to step 908.

At step 908, each sample of a set of modulation frequency samples can be multiplied by the lesser value. For example, the set of modulation frequency samples can be sine-wave samples generated by generator 812 and the samples can be multiplied by the lesser value by the multiplier 810. As discussed more fully below with respect to an illustrative numerical example, each sample can be selected to achieve a desired modulation frequency. For example, as discussed above, one such frequency can correspond to a frequency that is not perceptible by the human eye. Moreover, the number of modulation frequency samples employed can correspond to the number of samples in a modulated sample set of pixel values. As discussed above, a modulated sample set of pixels values can be generated by modulator 204 to increase the display rate of a video incorporating anti-camcorder features. For example, if the display rate of an original video stream is 24 Hz and the desired frame rate of an anti-camcorder video is approximately 120 Hz, then the number of samples in the sample set can be five. The method 900 then proceeds to step 910.

At step 910, the original pixel bit value can be added to the multiplied modulation frequency samples to form a raw modulated sample set of pixels corresponding to the frame location of the original pixel. For example, the original pixel bit value can be added to the multiplied modulation frequency samples by adder 808 and the raw modulated sample set can be output in line 813. The method 900 then proceeds to step 912.

At step 912, the sample set can be corrected. For example, as discussed more fully below, one or more pixels in a sample set can be corrected such that the sum of the pixels in a sample set is equal to the original pixel value multiplied by the number of pixels in the sample set. Equivalently, one or more pixels in a sample set can be corrected such that the average bit value of the pixels in the sample set, which corresponds to a display set, is the original pixel value. The correction module 814, for example, can perform step 912. The modulated and corrected samples can then be output by the modulator 204 along line 816.

It should be noted that the modulation frequency samples that are multiplied by the lesser value can alternatively be selected such that their average is zero. In this way, the sample set need not be corrected, as the average of the pixel values of the modulated sample would be the original pixel value or close to the original pixel value. As discussed above, it is desirable that the average brightness of the samples in the displayed is the brightness of the original pixel so that a human eye would not perceive modulation effects. It should further be noted that the modulation can be configured so that the minimum and maximum values possible for a pixel, which is, in this particular example, 0 and 4,095, respectively, for a 12-bit input pixel, are not modulated. As depicted above, in accordance with method 900, if the original pixel value is 0 or 4,095, the lesser value (e.g., the output of the Minimum Circuit Module 804) is 0. As such, the sample set (e.g., the output of adder 808) is simply the original pixel bit value. This feature can be included to ensure that a pixel at a minimum or maximum brightness is not modulated. If a pixel at a minimum or maximum brightness is modulated, then the average of the bit values of the sample set can not be the original pixel value. The method 900 is then exited and the method 600 proceeds to step 606.

Returning now to the method 600 of FIG. 6, at step 606, the portions in the modulated sample set can be segmented into MSB and LSB for each portion in the sample set, as described above, for example, with respect to segmentor 206. It should be understood, however, that the segmentation step can be performed before the modulation step and/or the multiplication step. Similarly, the segmentation step can be performed before repeating pixel information, which is discussed with respect to FIG. 8. For example, as described more fully below with respect to a numerical example, the original pixel value can be segmented and the MSB of the pixel value can be multiplied/repeated and modulated subsequent to segmentation. Thus, it should be understood that the term “modulating a portion of an original frame” and “modulate a portion of an original frame” includes modulating the MSB of a portion of an original frame subsequent to segmentation. Further, it should also be noted that the segmentation can be performed after multiplication, step 602, and before modulation, step 604. Thus, “segmenting the portion of an original frame” and “segment the portion of an original frame” includes segmenting a modulated and/or multiplied portion in a sample set as well as segmenting a portion of an original frame prior to modulation, multiplication and/or repetition of the portion of an original frame. The segmentor 206 can, for example, be configured to perform the various segmentations described herein. The method 600 then proceeds to step 608.

At step 608, a representative LSB value from the LSB of each portion in the sample set can be generated, as described above, for example, with respect to generator module 208. For example, the generating step can include dividing at least a part of the sum of the LSB of the portions in the sample set by the number of portions in the sample set, the result of which is the representative LSB value, as described above. Further, the part of the sum of the LSB of the portions in the sample set can be the fraction of the sum, as described above. In addition, it should be noted that in an alternative implementation, the representative LSB value can be generated at step 608 from the original pixel value, as discussed more fully below with respect to a numerical example. For example, if the original pixel value is segmented, the sum F, described above, can be the LSB of the original pixel value multiplied by the number of samples in the sample set or the number of samples in the display set. The representative LSB value can be determined as discussed above with respect to the generator module 208. Thus, the representative LSB value can be generated by dividing at least a part of a product of the LSB of the portion of an original frame and the number of portions in the display set by the number of portions in the display set, the result of which is the representative LSB value. It should also be understood that generator module 208 can be configured to generate the representative LSB value from segmentation of the original pixel value. The method 600 then proceeds to step 610.

At step 610, the MSB of the portions in the sample set can optionally be ranked, as described above, for example, with respect to ranking module 216. The method 600 then proceeds to step 612.

At step 612, a multiple of a minimum value of a least significant bit of a MSB of a modulated portion can be added to the MSB of a modulated portion, as described above, for example, with respect to adder 218 and below with respect to a numerical example. The method 600 then proceeds to step 614.

At step 614, the MSB of portions of one or more sample sets can be selected for output, as described above, for example with respect to selector 220. The method 600 then proceeds to step 616.

At step 616, the representative LSB value and the MSB of the portions in the sample set can be transmitted, for example, in the transmission stream, described above, for their concatenation and for presentation of the display set, as discussed above. The method 600 is then exited.

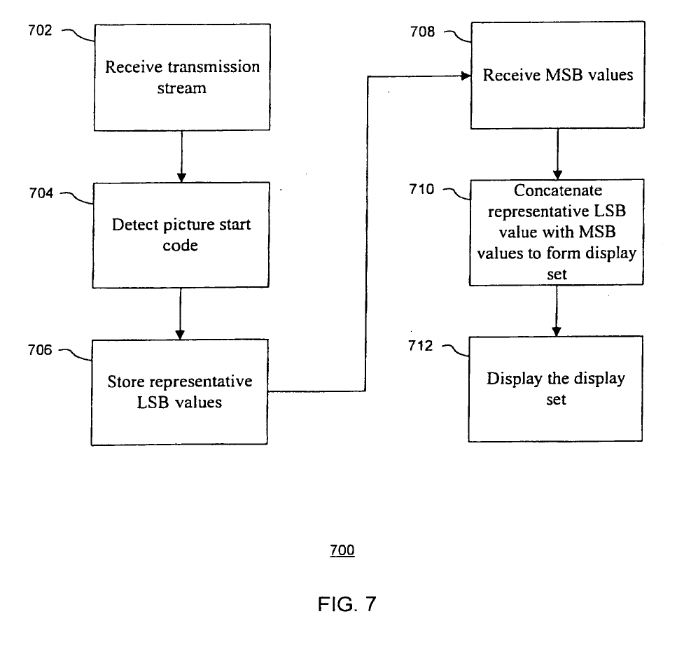

FIG. 7 depicts a high level flow diagram of a method for decoding an efficient bit-rate transmission stream incorporating anti-camcorder modulation in accordance with an embodiment of the present invention. Referring now to FIG. 7 with continuing reference to FIG. 3, a method for decoding an efficient bit-rate transmission stream incorporating anti-camcorder modulation is illustrated. The method 700 can begin at step 702 by receiving, for example, the transmission stream discussed at length above. The method 700 then proceeds to step 704.

At step 704, a picture code can be detected, as described above, for example, with respect to picture start code detection module 304. The method 700 then proceeds to step 706.

At step 706, the representative LSB values of some or all portions of one or more frames can be stored, as described above, for example, with respect to the store-and-retrieve LSB module 302. The method 700 then proceeds to step 708.

At step 708, the MSB values of some or all sample sets of one or more frames can be received, as described above, for example, with respect to concatenator 306. The method 700 then proceeds to step 710.

At step 710, MSB values and a representative LSB value can be concatenated to form a display set, as described above, for example, with respect to concatenator 306. The method 700 then proceeds to step 712.

At step 712, the display set can be displayed, as described above, for example, with respect to concatenator 306 and the concatenated values. In one implementation, the concatenated values can be complied to form a display frame, as discussed above.

Table 1, below depicts a specific numerical example illustrating a modulation operation described with respect to a sample set A-E for the method 900 of FIG. 9 as described above.

TABLE 1
Input pixel value 3300
Subtraction 795
Lesser value 795

| | | Sample A | Sample B | Sample C | Sample D | Sample E |
|---|---|---|---|---|---|---|
| I | | 1 | 2 | 3 | 4 | 5 |
| Angle | | 2.87979083 | 5.759582 | 8.639372 | 11.5191633 | 14.39895416 |
| sine(angle) | | 0.2588214 | −0.5 | 0.707112 | −0.8660303 | 0.965928977 |
| Modulated | raw | 3505.763 | 2902.497 | 3862.154 | 2611.506 | 4067.914 |
| sample set | | | | | | |
| | rounded | 3506 | 2902 | 3862 | 2612 | 4068 |
| Corrected | | 3416 | 2812 | 3772 | 2522 | 3978 |
| modulated | | | | | | |
| output | | | | | | |

Referring back to the method 900 of FIG. 9, in one embodiment of the present invention the input original pixel value received in step 902 can be 3300 and can correspond to one of a Red, Green, Blue signal. Further, for the sake of simplicity and consistency, the input pixel value can be a 12-bit value and the pixel can correspond to a video stream with a 24 Hz display rate. As discussed above with respect to step 904, the input pixel value can be subtracted from the maximum value and a pixel can have a value determined in accordance with equation one (1), which follows:

pixelₘₐₓ−pixelᵢₙₚᵤₜ=4095−3300=795. (1)

The lesser value of the result, in this case 795, and the original pixel value is determined, as described above with respect to step 906. In this example, 795 is the lesser value. As discussed above with respect to step 908, modulation frequency samples can be selected for multiplication by the lesser value. Although samples from a sine wave are selected in this particular example, the modulation frequency samples can be generated in other ways. As shown in Table 1, above, five samples are selected. The samples can be selected in accordance with the following angles in radians as characterized by equation two (2), which follows:

$$Angle = ( \frac{Modulation Frequncy}{Desired Frame Display Rate} ) \cdot 2 π n , n = 1 , 2 , 3 … i \qquad ( 2 )$$

in which “i” is the number of samples in the set. In this example, the modulation frequency is 55 Hz and the desired display frame rate is 120 Hz. As stated above, 55 Hz is a modulation frequency that is not perceptible by the human eye. However, other modulation frequencies can be employed, such as those between about 50 Hz and about 60 Hz, for example. Further, in this example “i” is five, corresponding to five samples, as the input display frame rate is 24 Hz and the desired frame display rate is 120 Hz. Further, as stated above, the number of samples taken can be varied. Table 1, above, lists the angles selected and the sines of the angles for respective samples A-E. Here, the sines of the angles are the modulation frequency samples to be multiplied by the lesser value. The multiplied modulation frequency samples are added to the input pixel value in accordance with step 910, the result of which is listed in Table 1 as the raw modulated sample set. Table 1 also lists the rounded modulated sample set, which is the raw modulated sample set rounded to the nearest integer.

Table 2, below, depicts a corrected modulated sample set which ensures that the average pixel brightness of the sample set is the pixel brightness of the original pixel.

TABLE 2

| | |
|---|---|
| Sum of rounded | 16950 |
| 5X Original pixel | 16500 |
| value | |
| Difference | −450 |
| Correction Factor | −90 |

Referring to Table 2 with continuing reference to Table 1 and FIG. 9, a modulated pixel is corrected such that an average bit value of a sample set of modulated pixels corresponding to a display set is the bit value of the portion of an original frame. Table 2 illustrates the calculation of a correction factor, as stated above with respect to step 912. As shown in Table 2, because the sum of the rounded modulated sample set is not equal to five times the original pixel value, the average of the modulated sample set pixel values is not the original pixel value. Thus, a correction factor can be determined in accordance with equation three (3), which follows:

$$Correction Factor = \frac{i ( input pixle value ) - {\sum }_{n = 1}^{i} {( Modulated Frequency Sample )}_{i}}{i} \qquad ( 3 )$$

The correction factor as depicted in equation (3) can be added to each modulation frequency sample, the result of which is listed in Table 1, above, as the corrected modulated output for samples A-E, respectively.

Table 3, below, depicts a specific example of generating MSB, LSB and a Representative LSB value from a modulated sample set. In Table 3 and referring to the method 600 of FIG. 6, continuing with the example for a 12-bit pixel input of 3300 described above for clarification purposes, binary pixel values in the modulated sample set are segmented to form initial MSB and LSB, denoted Am-Em and Al-El for samples A-E, respectfully, as discussed above with respect to step 606. In this particular example, the pixel value for a sample is segmented into a 6-bit MSB integer and a 6-Bit LSB fraction. However, as mentioned above, the pixel value of a sample can be segmented in other ways.

TABLE 3
Modulated Sample Set

| A | B | C | D | E |
|---|---|---|---|---|
| 3416 | 2812 | 3772 | 2522 | 3978 |

| | Initial MSB Sample | | | | |
|---|---|---|---|---|---|
| | Am | Bm | Cm | Dm | Em |
| Bit value | 3392 | 2752 | 3712 | 2496 | 3968 |

| | Initial LSB sample | | | | |
|---|---|---|---|---|---|
| | Al | Bl | Cl | Dl | El |
| Bit value | 24 | 60 | 60 | 26 | 10 |

| | Final MSB sample | | | | |
|---|---|---|---|---|---|
| | Am* | Bm* | Cm* | Dm* | Em* |
| Bit value | 3456 | 2816 | 3712 | 2496 | 3968 |

Representative LSB value

| Al* | Bl* | Cl* | Dl* | El* |
|---|---|---|---|---|
| 10 | 10 | 10 | 10 | 10 |

Display Set

| | | | | | Average of |
|---|---|---|---|---|---|
| A* | B* | C* | D* | E* | output |
| 3466 | 2826 | 3722 | 2506 | 3978 | 3300 |

Referring to Table 3, the values provided therein are in base 10. The bit value of the initial MSB and LSB of samples in the modulated sample set can be determined in base 10 in accordance with equations four (4) and five (5), which follow:

$$\begin{matrix}MSB = M \cdot INT ( \frac{Sample bit value}{M} ) , & ( 4 ) \\ LSB = Sample bit value - MSB , & ( 5 )\end{matrix}$$

wherein M is the minimum value of the least significant bit in the MSB and INTO is an operation that outputs the integer portion of the operand. For example, because the 12-bit pixel value is segmented into 6 MSB and 6 LSB, the least significant bit in the MSB portion is the bit in the sixth position. The minimum value of the bit in the sixth position corresponds to the value of 000001000000, which is 64 in base 10. The initial MSB and LSB of samples A-E are listed in Table 3, above.

Table 4, below, depicts representative LSB values, which can be determined by obtaining the fraction portion of the sum of the initial LSB values, as discussed above with respect to step 608 of the method 600 of FIG. 6.

TABLE 4

| Input pixel | | | |
|---|---|---|---|
| value of 3300 | F | I | f |
| Base 10 | 180 | 128 | 52 |
| Units of M | 2.8125 | 2 | .8125 |

In Table 4, as discussed above, LSB samples are 6-bit LSB, which range in value from 0 to 63. The sum of the 6-bit LSB for five LSB samples range in value from 0 to 315, the maximum of which is a 9-bit value. In units of M, the sum can occupy a range from 0 to (315/64)M or 4.921875M. In this example, F, denoted in Table 4, represents the sum of the initial LSB sample values, which can be segmented into an integer portion and a fraction portion, denoted as I and f, respectively. The integer and fraction portions can be determined in accordance with Equations 4 and 5, respectively, wherein the sample bit value corresponds to F and M corresponds to 64 in base 10. In units of M, for 6-bit MSB/6-bit LSB segmentation, F can occupy a range from 0 to (315/64)M or 4.921875M. Thus, the integer, I, portion of F, in units of M, can have a value from 0 to 4. Similarly, the fraction, f, portion of, F in units of M, can have a value from 0 to 63/64.

The Representative LSB value can be determined in accordance with equation six (6), which follows:

$$Representative LSB value = INT ( \frac{f}{i} + 0.5 ) , \qquad ( 6 )$$

wherein f is the fraction portion of the sum of the initial LSB values, i is the number of samples in the sample set, and INT( ) is an operation that outputs the integer portion of the operand. Equivalently, the Representative LSB value can correspond to f/i rounded to the nearest integer. In this example, for 6-bit MSB/6-Bit LSB segmentation with a 12-bit input pixel value of 3300, the Representative LSB is 10, as indicated in Table 3.

The I portion of the sum F, as discussed above, can be included within the MSB values of the sample set to ensure that brightness information is not lost. For example, as discussed above with respect to step 612, I can be distributed to the MSB of one or more pixels in the sample set by incrementing the MSB of one or more pixels in the sample set by one. The number of MSBs incremented can be determined by obtaining the value of I in units of M. Table 4 indicates the value of I in units of M for this example, which is (the value of I in base 10)/M or equivalently, in this example, (the value of I in base 10)/64.

Referring back to Table 3, because I has a value of two, two MSB values in the sample set can be incremented to form the final MSB values in the sample set, denoted Am*-Em*. For example, the values of MSB samples Am and Bm are incremented by 1 in units of M. Equivalently, M, which is 64 in this example, can be added to Am and Bm in base 10 to generate final MSB values Am* and Bm*, as illustrated in Table 3. Cm-Em remain unchanged. However, it should be noted that any MSB value in the sample set Am*-Em* can be incremented by the value of I one or more times as long as the incremented MSB result is not larger than an MSB of all ones. For example, a 6-bit MSB of all ones corresponds to 111111000000, or, in base 10, 4032. With reference to Table 3, Am can alternatively be incremented twice to form the final MSB values Am*=3520, Bm*=2752, Cm*=2112, Dm*=2496, Em*=3968, with Bm-Em remaining unchanged. In this way, a multiple of a minimum value of a least significant bit of a MSB of a modulated pixel can be added to the MSB of a modulated pixel.

Thus, in accordance with the example, for a sample set corresponding to an original pixel, one 4-bit LSB sample, which is the Representative LSB value, and five 6-bit samples, which is the final MSB values, are transmitted for concatenation and display. As opposed to transmitting the pixel values of each modulated pixel sample in the sample set, which amounts to five 12-bit samples or 60 bits, the number of bits transmitted can be reduced to 34 bits in accordance with an implementation of the present principles.

Additionally, Table 3 also indicates the 12-bit pixel values of each sample in the display set, denoted as denoted as A*-E*, respectively. As discussed above, the display set can be obtained by concatenating the MSB and LSB of each sample in the sample set, Am*-Em* and Al*-El*, respectively, by adding zeros between them. The average pixel value of the display set is the initial pixel value, as depicted in Table 3.

Furthermore, it should be understood that the segmentation, discussed above with respect to step 606, can be performed in other ways. For example, in an alternate embodiment of the present invention the segmentation can be performed such that 3, 4 or 5 MSB, or other values, for a 12-bit pixel input is transmitted in a sample set. As illustrated in Table 3, because the representative LSB is the same for all samples in the sample set, the MSB bits carry the modulation information. In this way, anti-camcorder effects can be determined by the MSB of the pixels or portions in the sample set. However, enough bits should be dedicated to carrying the modulation information to provide adequate anti-camcorder effects.

It should be also be understood that although segmentation has been described as being performed after modulation, in accordance with one or more embodiments of the present invention, the segmentation can be performed before modulation. For example, the input pixel value can be segmented into MSB and LSB using equations 4 and 5. For an input pixel value of 3300 segmented into 6-bit MSB and 6-bit LSB, the MSB corresponds to a value of 3264 and the LSB corresponds to a value of 36. In this case, the sum F, discussed above, can be determined according to equation seven (7), which follows:

F=(LSB of input pixel)·i, (7)

wherein i is the number of samples in the set. Here, with i equal to 5, the sum F is 180, the same value as obtained above where the segmentation was performed after modulation. The representative LSB value can be found by applying equations 4 and 5 to obtain the LSB of F, or f, and by applying equation 6, as discussed above.

However, it should be noted that any steps, actions and/or functions described above with respect to system 100, 200, 300, 800 and/or apparatus 500 can be incorporated into any one or more of methods 600, 700 and 900, which can themselves be combined in whole or in part.

Having described embodiments for methods, apparatuses and systems for reducing the transmission bit rate of a video stream subjected to anti-camcorder modulation (which are intended to be illustrative and not limiting), it is noted that modifications and variations can be made by persons skilled in the art in light of the above teachings. It is therefore to be understood that changes can be made in the particular embodiments of the invention disclosed which are within the scope and spirit of the invention as outlined by the appended claims. While the forgoing is directed to various embodiments of the present invention, other and further embodiments of the invention can be devised without departing from the basic scope thereof.

1. A method for reducing the transmission bit rate of a video stream subjected to anti-camcorder modulation comprising:
modulating a portion of an original frame such that a presentation of a display set of frame portions includes effects that are perceptible within a copy of the presentation recorded by a recording device but are imperceptible to a human upon presentation;
segmenting the portion of an original frame into most significant bits (MSB) and least significant bits;
generating a representative LSB value; and
transmitting the representative LSB value and MSB of a plurality of modulated portions for concatenation with the representative LSB value to form a display for presentation.

2. The method of claim 1, wherein the generating step comprises dividing at least a part of a sum of LSB of a sample set of portions by the number of portions in the sample set, the result of which is the representative LSB value.

3. The method of claim 1, wherein the generating step comprises dividing at least a part of a product of the LSB of the portion of an original frame and the number of portions in the display set by the number of portions in the display set, the result of which is the representative LSB value.

4. The method of claim 1, further comprising:
correcting a modulated portion such that an average bit value of a sample set of modulated portions corresponding to the display set is the bit value of the portion of an original frame.

5. The method of claim 1, further comprising:
adding a multiple of a minimum value of a least significant bit of MSB of a modulated portion to the MSB of a modulated portion.

6. The method of claim 1, further comprising the step of:
multiplying the portion of an original frame into a sample set of portions, wherein each portion in the sample set corresponds to the same frame location.

7. The method of claim 1, further comprising the step of:
concatenating, for the MSB of each portion in a sample set, the MSB of a portion in the sample set with the representative LSB value to generate the display set.

8. The method of claim 7, wherein the representative LSB value is included in a plurality of frames corresponding to the display set.

9. The method of claim 7, wherein the concatenation includes adding zeros between the MSB of a modulated portion and the representative LSB value.

10. The method of claim 1, wherein the modulation is configured such that anti-camcorder effects are determined by the MSB of modulated portions in a sample set.

11. A system for reducing the transmission bit rate of a video stream subjected to anti-camcorder modulation comprising:
a coder configured to transmit a representative least significant bit value and most significant bits of a plurality of modulated portions, the coder including:
a modulator configured to modulate a portion of an original frame such that the presentation of a display set of frame portions includes effects that are perceptible within a copy of the presentation recorded by a recording device but are imperceptible to a human in the presentation,
a segmentor configured to segment a portion of an original frame into MSB and LSB, and
a generator module configured to generate a representative LSB value;
and
a decoder including a concatenator configured to concatenate, for the MSB of each of the plurality of modulated portions, the MSB of a modulated portion with the representative LSB value to generate the display set.

12. The system of claim 11, wherein the generator module is further configured to divide at least a part of a sum of LSB of portions in a sample set by the number of portions in the sample set, the result of which is the representative LSB value.

13. The system of claim 11, wherein the generator module is further configured to divide at least a part of a product of the LSB of the portion of an original frame and the number of portions in the display set by the number of portions in the display set, the result of which is the representative LSB value.

14. The system of claim 11, further comprising:
a correction module configured to correct a modulated portion such that an average bit value of a sample set of modulated portions corresponding to the display set is the bit value of the portion of an original frame.

15. The system of claim 11, further comprising:
an adder configured to add a multiple of a minimum value of a least significant bit of MSB of a modulated portion to the MSB of a modulated portion.

16. The system of claim 11, wherein the modulator is further configured to multiply the portion of an original frame into a sample set of portions, wherein each portion in the sample set corresponds to the same frame location.

17. The system of claim 11, wherein the representative LSB value is included in a plurality of frames corresponding to the display set.

18. The system of claim 11, wherein the concatenation includes adding zeros between the MSB of a modulated portion and the representative LSB value.

19. The system of claim 11, wherein anti-camcorder effects are determined by the MSB of modulated portions in a sample set.

20. An apparatus for reducing the transmission bit rate of a video stream subjected to anti-camcorder modulation, comprising:
a modulator configured to modulate a portion of an original frame such that a presentation of a display set of frame portions includes effects that are perceptible within a copy of the presentation recorded by a recording device but are imperceptible to a human in the presentation;
a processor configured to:
segment the portion of an original frame into most significant
bits (MSB) and least significant bits (LSB),
generate a representative LSB value, and
drive the transmission of the representative LSB value and MSB of a plurality of modulated portions for concatenation with the representative LSB value to form the display set and for presentation of the display set; and
a memory configured to store MSB and LSB of portions.
